(19) United States
(12) Patent Application Publication
(10) Pub. No.: US 2010/0169822 A1
(43) Pub. Date: Jul. 1, 2010

(54) INDICATION TO ASSIST A USER IN PREDICTING A CHANGE IN A SCROLL RATE

(75) Inventor: Gerrit Hollemans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,573

(22) PCT Filed: Nov. 28, 2006
(86) PCT No.: PCT/IB2006/054493

§ 371 Date: May 30, 2008

Related U.S. Application Data
(60) Provisional application No. 60/741,296, filed on Dec. 1, 2005.

(51) Int. Cl. G06F 3/048; G08B 23/00

(52) U.S. Cl. 715/784; 340/501

(57) ABSTRACT

A user interface of a device is provided for displaying an environment that is visually larger than a display area. The user interface includes a scroll function that positions selected portions of the environment within the display area. A scroll rate of the user interface changes as the scroll function is continued. The user interface produces an indication to alert a user that a change in scroll rate is imminent.

The present invention relates to a system, and a method for providing indications to a user that are related to a visual scrolling rate within a user interface.

Computers are today used extensively by many users to implement many applications. Users can interact through a user interface (UI) provided by an application running on the computer with a visual environment displayed by a computer on a display device to perform functions on the computer, play a game, experience a simulation or virtual reality environment, use a computer aided design (CAD) system, browse the World Wide Web, or otherwise influence events or images depicted on the screen. UI's present visual images which describe various visual metaphors of an operating system, an application, etc. implemented on the computer.

The user typically moves a user-controlled object, such as a cursor or pointer, across a computer screen and onto other displayed objects or screen regions, and then inputs a command to execute a given selection or operation. Other applications or visual environments also may provide user-controlled objects such as a cursor and include browsers and other applications displaying web pages and other environments offered on the World Wide Web of the Internet, CAD applications, video games, virtual reality simulations, etc. In some computer environments, the user may provide input to control a 3-dimensional (3-D) view of the environment, as in CAD or 3-D virtual reality applications.

The user interaction with and manipulation of the computer environment is achieved using any of a variety of types of human-computer interface devices that are connected to the computer controlling the displayed environment. A common interface device for UI's is a mouse or trackball. A mouse is moved by a user in a planar workspace to move an object such as a cursor on the 2-dimensional display screen in a direct mapping between the position of the user manipulation and the position of the cursor. This is typically known as position control, where the motion of the object directly correlates to motion of the user manipulation. Oftentimes, a displayed environment is visually larger than the display capabilities of a computer display. To facilitate viewing of the displayed environment, the UI provides for an ability to scroll within the environment to visually reach an area of the environment that was not previously displayed.

One drawback to a traditional mouse is that functions such as scrolling a visual environment are awkward to perform, since the user must use the cursor to drag a displayed scroll bar. These types of functions are often more easily performed by speed control devices, such as devices that have an indirect or abstract mapping of the user manipulation to the object, such as pressure-sensitive devices. Scrolling text in a window is better performed as a speed control task, since the scrolling is not directly related to the planar position of a mouse. Similarly, the controlled velocity of a simulated vehicle is suitable for a speed control paradigm.

To allow the user easier control of scrolling when using a mouse, a scroll wheel or mouse wheel has been developed and has become quite common on computer mice. A scroll wheel is a small finger wheel provided on a convenient place on the mouse, such as between two mouse buttons, which the user may rotate to control a scrolling function. Most commonly, a portion of the wheel protrudes out of the top surface of the mouse which the user can move his or her finger over. The wheel typically includes a rubber or other frictional surface to allow a user's finger to easily rotate the wheel. The wheel is most commonly used to scroll the visual environment without having to use a scroll bar and without selecting a separate scrolling control.

Scrolling through a visual environment through a UI is a very common task on electronic devices, including but not limited to computers, personal digital assistants (PDAs), mobile phones, and portable media players. For the purpose of simplifying the following description, unless specified otherwise, each of these devices and others will be referred to herein simply as a computer or computers. For large visual environments, scrolling can become time consuming as the user simply has to wait until a target location within the visual environment appears. For this reason, it is beneficial to the user to have some means of control over the scroll speed. It is beneficial if the portion of the visual environment that that passes through a displayed area in a given amount of time is in some way under the user control. For example, it is beneficial if the number of items within a displayed list that pass through the displayed area in a given amount of time is under the user control.

Some applications running on the computer bring the scroll speed under explicit user control. For example, some applications operate together with the scroll wheel such as by the user depressing the scroll wheel. After depression of the scroll wheel, the further the user moves the cursor away from the point where the user depressed the scroll wheel, the higher the scroll speed. A further refinement of control of the scroll speed is provided by Koninklijke Philips Electronics N.V in a device called Superscroll™ that enables the user to control the scroll speed by applying different levels of pressure on a button that controls the scrolling. The harder the user presses the button, the higher the scroll speed.

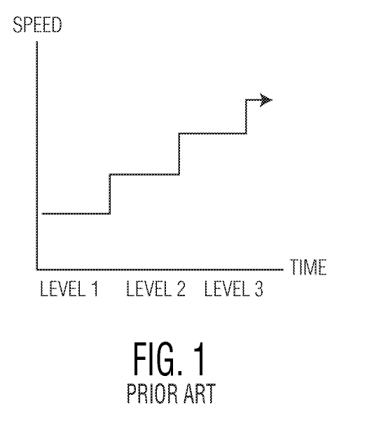

To facilitate continued scrolling, other applications increase the speed of scrolling one or more times during continued scrolling after a predetermined period of time as shown in FIG. 1. FIG. 1 depicts how a scroll speed, shown as varying in a vertical direction, varies over a duration of scrolling, shown as varying in a horizontal direction. As the user continues to scroll over a period of time, the speed of scrolling increases incrementally from a level 1 to a level 2. A longer duration of scrolling may lead to the speed of scrolling increasing again from a level 2 to a level 3. This may continue or a maximum scrolling speed may at some time be reached. For example, when the user continues scrolling for more than 10 seconds, the speed of scrolling may be doubled, etc.

This increase in scroll speed is not always desired by the user. It may happen that such an increase in scrolling speed comes just before a target area within the visual environment is reached, making the user scroll beyond the target area. Furthermore, the increase in scroll speed may disorient the user and the eventual scrolling speed may be faster than the user desires.

U.S. Patent Publication No. 2004/0108992, filed Oct. 20, 2003, entitled “Isotonic-Isometric Haptic Feedback Interface,” by Rosenberg, which is incorporated by reference herein, discloses a system for adding a sensory feedback, such as a jolt or vibration to the scroll wheel to indicate to the user an event, such as a page break or a speed of scrolling. Accordingly, during scrolling, a user may be provided this sensory feedback at a measured speed that may be proportional to the speed of scroll. Similarly, European Patent No. EP 0880091, filed May 19, 1998, entitled “A Method and an Arrangement for Scrolling Information Presented on a Display of a Mobil Station,” by Panu Korhonen, which is incorporated by reference herein, discloses a system for adding an auditory feedback to a speed of scrolling.

However, there is a problem in that in practice the user can not predict when the scrolling speed will change (e.g., increase, decrease). Using trial and error, the user may get used to the change in speed, but this is tedious, may be different within different applications, needs to be remembered by heart, and results in the user mentally counting the seconds while scrolling. Accordingly, the user typically may only react to the already changed speed, for example, by stopping the scrolling.

It is an object of the present system to overcome these and other disadvantages in the prior art.

In accordance with an embodiment of the present system, a user interface of a device is provided for displaying an environment that is visually larger than a display area. The user interface includes a scroll function that positions selected portions of the environment within the display area. A scroll rate of the user interface changes as the scroll function is continued. The user interface produces an indication to alert a user that a change in scroll rate is imminent.

In one embodiment, the user interface produces a first indication that is proportional to the scroll rate, and when the change in scroll rate is imminent, a second indication is produced. The second indication may be proportional to the scroll rate that would be produced if the change in scroll rate occurs. The alert may be at least one of a tactile alert, an auditory alert, and a visual alert. In the same or another embodiment, the scroll function may be initiated by a first scroll actuation and the rate of scroll may not change if a second scroll actuation occurs within a predetermined interval of time after the first scroll actuation is stopped.

In another embodiment, the scroll function may be initiated by a first scroll actuation and the rate of scroll may return to a predetermined rate of scroll if a second scroll actuation occurs within a predetermined interval of time after the first scroll actuation is stopped.

The following are descriptions of illustrative embodiments that when taken in conjunction with the following drawings will demonstrate the above noted features and advantages, as well as further ones. In the following description, for purposes of explanation rather than limitation, specific details are set forth such as the particular architecture, interfaces, techniques, etc., for illustration. However, it will be apparent to those of ordinary skill in the art that other embodiments that depart from these specific details would still be understood to be within the scope of the appended claims. Moreover, for the purpose of clarity, detailed descriptions of well-known devices, circuits, and methods are omitted so as not to obscure the description of the present invention.

It should be expressly understood that the drawings are included for illustrative purposes and do not represent the scope of the present invention.

FIG. 1 depicts how a prior system scroll rate, may vary over a duration of scrolling;

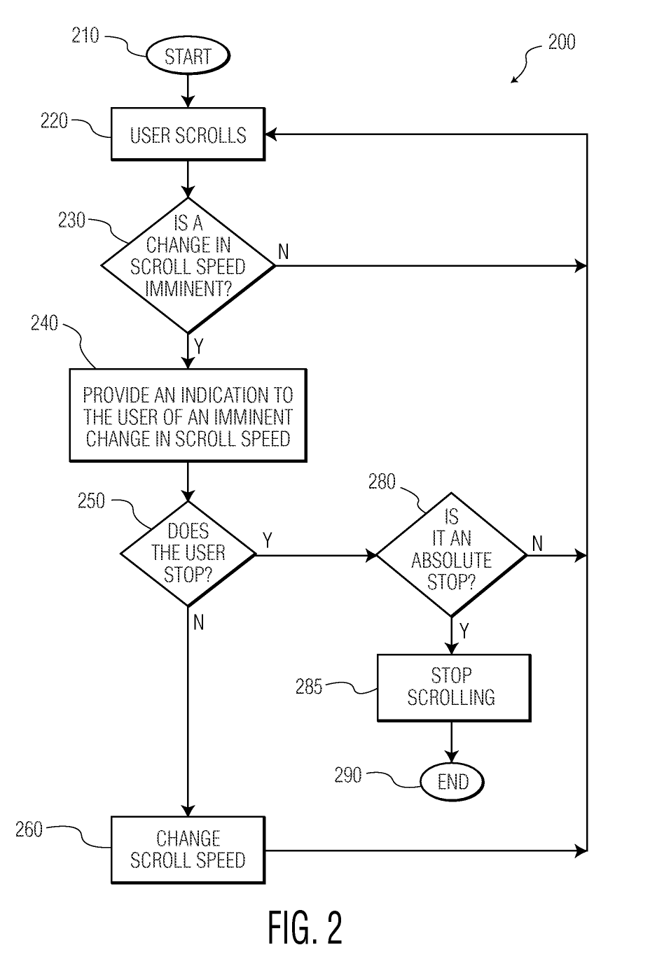

FIG. 2 is an exemplary flow diagram illustrating operation in accordance with an embodiment of the present system;

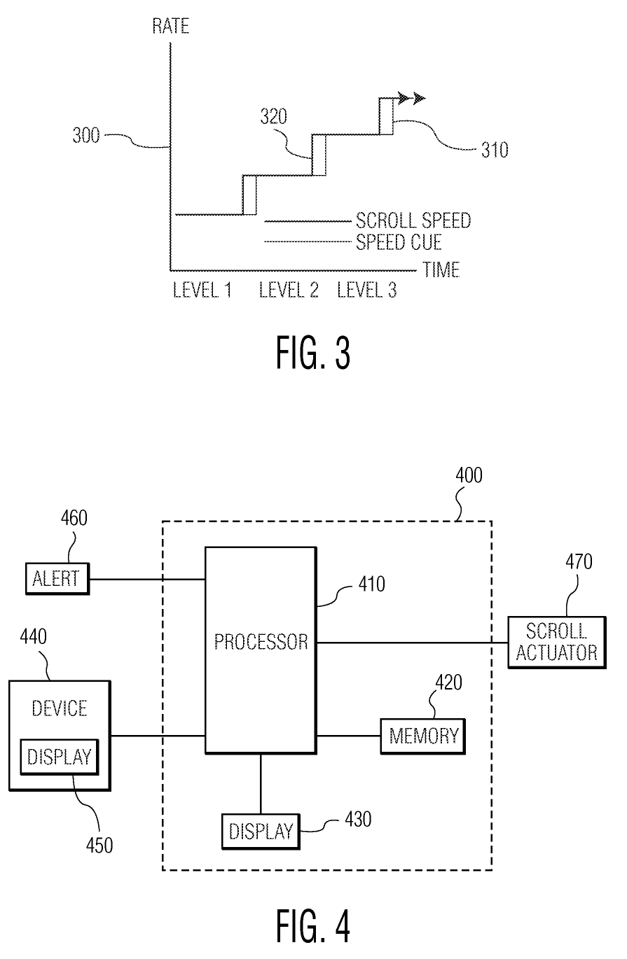

FIG. 3 illustrates how a rate of occurrence of scrolling and an indication of scrolling, may vary over a duration of scrolling according to an embodiment of the present system; and

FIG. 4 shows a device 400 in accordance with an embodiment of the present system.

In accordance with an embodiment of the present system, a user is provided an indication that a change in scrolling rate is imminent. As used herein, the term rate is intended to include, without limitation, velocity (speed) and/or acceleration, unless specified otherwise. In this way, the user is provided warning that the scrolling rate is about to change, which provides the user an opportunity to react, when desired, before the change. In a case, wherein the change in scrolling rate is desired, the indication also provides the user an opportunity to become oriented to the change in scroll rate in a shorter period of time then in prior systems.

FIG. 2 is an exemplary flow diagram illustrating operation in accordance with an embodiment of the present system. As shown, during act 210, a user initiates a scrolling action within a UI. The action continues during act 220 for some period of time, which in an embodiment may be predetermined. During act 230, the system determines whether a change in scroll rate is imminent. In an event, wherein a change in scroll rate is not imminent, the system returns to act 220 and scrolling continues. In an event wherein the system determines during act 230 that a change in scroll rate is imminent, then during act 240 an indication is provided to the user that there is an imminent change in scroll rate. By imminent, what is intended is that at some time prior to a change in scroll rate, the user is provided an indication during act 250 that provides a user an opportunity to stop, either absolutely (no continued scrolling, see acts 285 and 290) or just continue at the present scroll rate as shown during act 220. For example, the user may be provided an indication in the range of 0.1-2.0 seconds prior to the change in scroll rate although this range is not a required feature of the present invention. As would be readily appreciated, what would constitute imminent may vary for different applications and for different indications (e.g., sound indication as opposed to a vibration indication, etc.).

In another embodiment, when the user stops scroll actuation shortly after the change in speed and thereafter restarts the scrolling, the system may learn that this may indicate that the notice time period provided by the indication is set too short. In a case where this user behavior is repeated on several occasions, the system may provide the indication a longer period of time prior to the change in scroll speed.

The determination whether a user stop is absolute is made during act 280. Should the user not stop, a change in scroll rate will occur during act 260 and thereafter, scrolling continues at the changed scroll rate during act 220. As is readily apparent, although not shown, any time the user absolutely stops scroll actuation, the system will perform acts 285, 290.

The indication of imminent scroll rate change may be in any sensory form including a tactile indication, an auditory indication, a visual indication, etc. As used herein, the term indication is intended to include, without limitation, a tactile indication, an auditory indication, and/or a visual indication, unless specified otherwise. In some embodiments of a UI, a visual indication may be perceived as distracting the user from visually perceiving the scrolling itself which may have an adverse effect of potentially causing the user to miss the a desired target area within the visual environment. In this or other embodiments of a UI, the indication of imminent scroll rate change may be in the form of a tactile indication and/or an auditory indication such as a vibration of a scroll wheel and/or a ticking sound.

In one embodiment, to alleviate a need for the user to consciously learn a meaning of another indication of the application, the vibration, sound, and/or other sensory feedback that is used to warn the user of imminent scroll rate increase may already be linked to the scrolling. For example, in an application that presents a ticking sound each time a given portion of an environment scrolls, prior to the actual change in scrolling rate, the ticking frequency may change as shown in FIG. 3. As the sound has been consistent (e.g., synchronous) with the scrolling, the change in ticking frequency will alert the user to think that the rate of the scrolling is about to change. The user then may decide to react to the change in ticking frequency during act 250 as shown in FIG. 2.

Similarly, in an embodiment wherein a scrolling wheel or other scrolling actuator vibrates each time a portion of the visual environment scrolls, the change in the frequency of vibration will alert the user to recall that the rate of the scrolling is about to change. The change in vibration of the scrolling actuator may in one embodiment be initiated by a piezoelectric element operably coupled to the scrolling actuator. As would be apparent to a person of ordinary skill in the art, other sensory indications may be similarly utilized.

FIG. 3 illustrates how a rate of occurrence of an item, such as a rate of scroll and a rate of an indication, shown as varying in a vertical direction, may vary over a duration of scrolling, shown as varying in a horizontal direction. Particularly, FIG. 3 shows a chart 300 that illustrates how, as the user continues to scroll over a period of time, the rate of scrolling may change incrementally from level 1 through level 2 to level 3, etc. The scrolling rate, including a change in scrolling rate is shown by a staircase function 310. In accordance with an embodiment of the present system, the change in scroll rate is preceded by an indication that is illustratively depicted by a staircase function 320. Staircase function 320 depicts an embodiment wherein the indication of an imminent change in scroll rate is provided by a change in an indication rate that precedes the change in scroll rate. For example, in a system that provides an indication rate that typically is proportional to the scroll rate, in accordance with an embodiment of the present system, a change in scroll rate is preceded by a change in the indication rate to notify the user that an imminent change in scroll rate is about to occur.

When the user is alerted to expect the scrolling rate to change, the user may accept the change (see, FIG. 2, acts 250 through acts 260, 220) or reject the change (see, FIG. 2, acts 250 through acts 280, 220 or through acts 280, 285, 290). Only in the latter case is a reaction from the user required. For example, the user may release the scroll actuator to stop the scrolling. When the user starts the scrolling again, scrolling may start at a same initial rate as previously. In this way, the user has effectively prevented the change in scroll rate (rather than reacted to it).

This type of interaction is fine for applications that have only two levels of scroll rate, but it may not work well for the user if the application has three or more rate levels. Consider a user that likes the application to scroll at rate level 2. After some time scrolling at rate level 2, the application further increases the rate of scrolling to level 3, a level that the user may not prefer. If the user then stops and restarts the scrolling, each time the application may start at level 1 again, which may be too slow for the user.

In one embodiment of the present system, to assist the user in not starting the scroll rate each time at the slowest rate when the user stops actuation of scrolling, the user may be enabled to stop actuation and shortly, before some predetermined interval of time, restart actuation again (e.g., release and quickly repress a button or scroll wheel). In this embodiment, if this is done sufficiently fast in succession for the system (e.g., before the predetermined interval of time), the scroll rate may stay at the level where it was at the time of the stopped actuation. In another similar embodiment, the scroll rate may return to some predetermined level (e.g., level 2) as opposed to returning to an initial level (e.g., level 1). In an event wherein the user waits a bit longer (e.g., after the predetermined interval of time), the scroll rate may restart at the initial level again (e.g., level 1).

In one embodiment, the present system may alleviate the burden on the user of the application repeatedly changing the scroll rate and the user having to prevent the change, if desired, by repeatedly stopping the scrolling actuation and quickly restarting the scrolling actuation. In this embodiment, the present system may learn, for example by monitoring user action over a period of time, that the stop and quick restart implies that the user does not desire the scroll rate to change further. In this embodiment, only when the user stops scroll actuation and waits long enough (e.g., after the predetermined amount of time) to restart will the system again begin to change the scroll rate over time.

FIG. 4 shows a device 400 in accordance with an embodiment of the present system. The device has a processor 410 operationally coupled to a memory 420, a display 430, a scroll actuator 470, and a device 440. The memory 420 may be any type of device for storing application data. The application data is received by the processor 410 for configuring the processor 410 to perform operation acts in accordance with the present system. The operation acts include controlling at least one of the display 430 or the display 450 to display a UI that depicts a visual environment that is larger than the respective displays 430, 450. The scroll actuator 470 operates on the processor 410 together with the application to actuate scrolling as discussed above. An alert signal indicating an imminent change in scroll speed is produced by the processor 410 through an alert generator 460 and/or the scroll actuator 470. The alert may include one or more of a tactile alert, an auditory alert, and visual alert. The device 440 is operationally coupled to the display 450 however, the device may simply be a display, such as a liquid crystal display (LCD) or a cathode ray tube (CRT). The device 440 may also perform other operations including displaying television signals, displaying a gaming environment, displaying a CAD environment, etc. Clearly only a single display is required for operation, although both displays 430, 450 may also be utilized.

The embodiments described above are intended for purposes of illustration only, and should not be construed as limiting the appended claims to any particular embodiment or group of embodiments. Numerous alternative embodiments may be devised by those having ordinary skill in the art without departing from the spirit and scope of the following claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts or steps is intended to be required unless specifically indicated.

1. A user interface of a device for displaying an environment that is visually larger than a display area, the user interface comprising:
a scroll function configured to position selected portions of the environment within the display area, wherein a scroll rate changes as the scroll function is continued; and
an indication configured to alert a user that a change in scroll rate is imminent.

2. The user interface of claim 1, wherein the indication is a first indication and the alert is a first alert, the user interface comprising a second indication that is configured to produce a second alert to the user at a rate that is proportional to the scroll rate, and wherein when the change in scroll rate is imminent, the second alert is replaced by the first alert.

3. The user interface of claim 2, wherein the first alert is produced at a rate that is proportional to the scroll rate that is produced if a change in scroll rate occurs.

4. The user interface of claim 1, wherein the alert is produced a predetermined time before the change in scroll rate.

5. The user interface of claim 1, wherein the alert is at least one of a tactile alert, an auditory alert, and a visual alert.

6. The user interface of claim 1, wherein the alert is a vibration alert.

7. The user interface of claim 6, wherein the user interface is configured to generate a signal for a piezoelectric device to initiate the vibration alert.

8. The user interface of claim 1, wherein the alert is a clicking alert and the user interface is configured to generate a signal for an auditory device to initiate the clicking alert.

9. The user interface of claim 1, wherein the scroll function is configured to be initiated by a first scroll actuation and is configured to not change the rate of scroll if a second scroll actuation occurs within a predetermined interval of time after the first scroll actuation is stopped.

10. The user interface of claim 1, wherein the scroll function is configured to be initiated by a first scroll actuation and is configured to return to a predetermined rate of scroll if a second scroll actuation occurs within a predetermined interval of time after the first scroll actuation is stopped.

11. An application embodied on a computer readable medium (420) configured to produce a user interface to manipulate a visual environment that is visually larger than a display area, the application comprising:
a portion configured to visually scroll portions of the environment within the display area, wherein a scroll rate changes as the scroll function is continued; and
a portion configured to produce an indication to alert a user that a change in scroll rate is imminent.

12. The application of claim 11, wherein the indication is a first indication and the alert is a first alert, the application comprising a portion configured to produce a second indication to the user at a rate that is proportional to the scroll rate and when the change in scroll rate is imminent, to replace the second alert by the first alert.

13. The application of claim 12, wherein the application is configured to produce the first alert at a rate that is proportional to the scroll rate that is produced if the change in scroll rate occurs.

14. The application of claim 11, wherein the application is configured to produce an output for generating the alert that is at least one of a tactile alert, an auditory alert, and a visual alert.

15. The application of claim 11, wherein the portion configured to visually scroll is configured to be initiated by a first scroll actuation and is configured to not change the rate of scroll if a second scroll actuation occurs within a predetermined interval of time after the first scroll actuation is stopped.

16. The application of claim 11, wherein the portion configured to visually scroll is configured to be initiated by a first scroll actuation and is configured to return to a predetermined rate of scroll if a second scroll actuation occurs within a predetermined interval of time after the first scroll actuation is stopped.

17. A device having a user interface to manipulate a visual environment that is visually larger than a display area, the device comprising:
a means for visually scrolling portions of the environment within the display area, wherein a scroll rate changes as the scroll function is continued; and
a means for producing an indication to alert a user that a change in scroll rate is imminent.

18. The device of claim 17, wherein the indication is a first indication and the alert is a first alert, the device comprising a means for producing a second indication to the user at a rate that is proportional to the scroll rate and when the change in scroll rate is imminent, to replace the second alert by the first alert.

19. The device of claim 17, wherein the device comprises a means to produce an output for generating the alert that is at least one of a tactile alert, an auditory alert, and a visual alert.

20. The device of claim 17, wherein the means for visually scrolling is configured to be initiated by a first scroll actuation and is configured to not change the rate of scroll if a second scroll actuation occurs within a predetermined interval of time after the first scroll actuation is stopped, or is configured to return to a predetermined rate of scroll if a second scroll actuation occurs within the predetermined interval of time after the first scroll actuation is stopped.
